(19) United States
(12) Patent Application Publication
(10) Pub. No.: US 2024/0165928 A1
(43) Pub. Date: May 23, 2024

(54) TILE BACKER BOARD

(71) Applicant: ILLINOIS TOOL WORKS INC., GLENVIEW, IL (US)

(72) Inventors: Michael J. RANCICH, Houston, TX (US); Taylor K. JOHNSON, Tomball, TX (US)

(73) Assignee: ILLINOIS TOOL WORKS INC., GLENVIEW, IL (US)

(21) Appl. No.: 18/281,504

(22) PCT Filed: Mar. 10, 2022
(86) PCT No.: PCT/US2022/019769

§ 371 Date: Sep. 11, 2023

Related U.S. Application Data
(60) Provisional application No. 63/159,789, filed on Mar. 11, 2021.

(51) Int. Cl. B32B 27/06; B32B 5/02; B32B 5/18; B32B 7/02; B32B 27/08; B32B 27/12; B32B 27/30; B32B 27/32; B32B 27/36

(52) U.S. Cl. CPC B32B 27/065; B32B 5/022; B32B 5/18; B32B 7/02; B32B 27/08; B32B 27/12; B32B 27/308; B32B 27/32; B32B 27/36; B32B 2250/05; B32B 2250/40; B32B 2266/0228; B32B 2270/00; B32B 2307/718; B32B 2307/7265; B32B 2307/7376; B32B 2419/04

(57) ABSTRACT

A moisture resistant composite backing board that includes a polystyrene foam core and a composite face structure laminated to each face of the foam core. The composite face structure includes an outer non-woven fabric layer; a central film layer; and an inner film layer, wherein the central film layer and the inner film layer include distinct materials having distinct properties. The composite face structure is laminated to each side of the polystyrene foam core along the inner film layer.

### BACKGROUND OF THE INVENTION

### Field of the Invention

This invention relates generally to a tile backer board particularly suited for wet environments like bath or shower enclosures.

### Description of Prior Art

Structural panels are used in showers and baths and similar wet environments to provide waterproofing and a surface for tile adhesion. Traditional panels comprise water resistant drywall or cementitious panels which are heavy, brittle and require an additional waterproofing coating or membrane. Therefore, there exists a need for a structural panel board that is lightweight, easy to transport, handle and install and provides the benefits of waterproofing and tile adhesion necessary for such wet environments.

One existing flexible tile membrane is taught in US2014/0377519, which is incorporated herein by reference.

### SUMMARY OF THE INVENTION

The present invention is directed to a structural panel that includes a strong waterproof film layer as well as a central polystyrene foam core to provide a high barrier to liquid and gaseous water penetration with good nail and screw pull through resistance as compared to the prior art.

### BRIEF DESCRIPTION OF THE DRAWINGS

The above-mentioned and other features and objects of this invention will be better understood from the following detailed description taken in conjunction with the drawings wherein:

FIG. 1 shows a schematic of a backer board facer structure, according to an embodiment of this invention;

FIG. 2 shows a schematic of a backer board facer structure, according to an embodiment of this invention;

FIG. 3 shows a schematic of a backer board facer structure, according to an embodiment of this invention;

FIG. 4 shows a schematic of a backer board facer structure, according to an embodiment of this invention;

FIG. 5 shows a schematic of a backer board facer structure, according to an embodiment of this invention;

FIG. 6 shows a schematic of a backer board facer structure, according to an embodiment of this invention;

FIG. 7 shows a schematic of a finished backer board, according to an embodiment of this invention; and

FIG. 8 shows a schematic of a finished backer board, according to an embodiment of this invention.

The above-described drawings are schematic and therefore not to scale.

### DESCRIPTION OF PREFERRED EMBODIMENTS

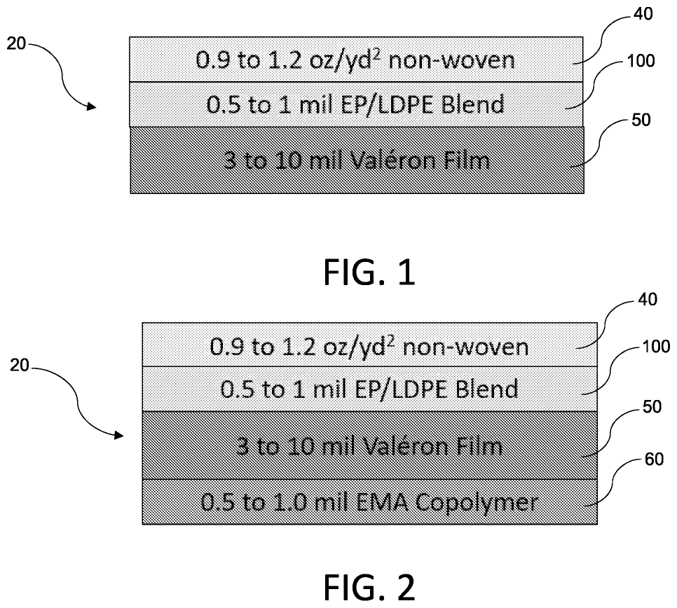

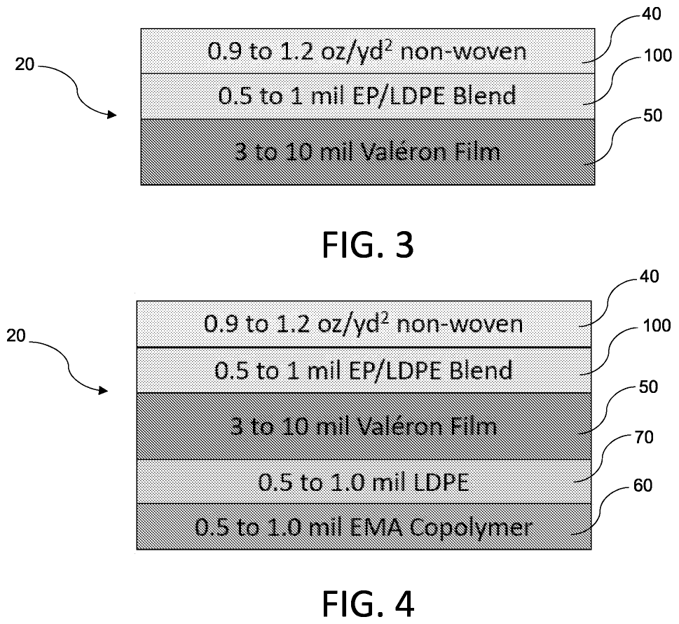

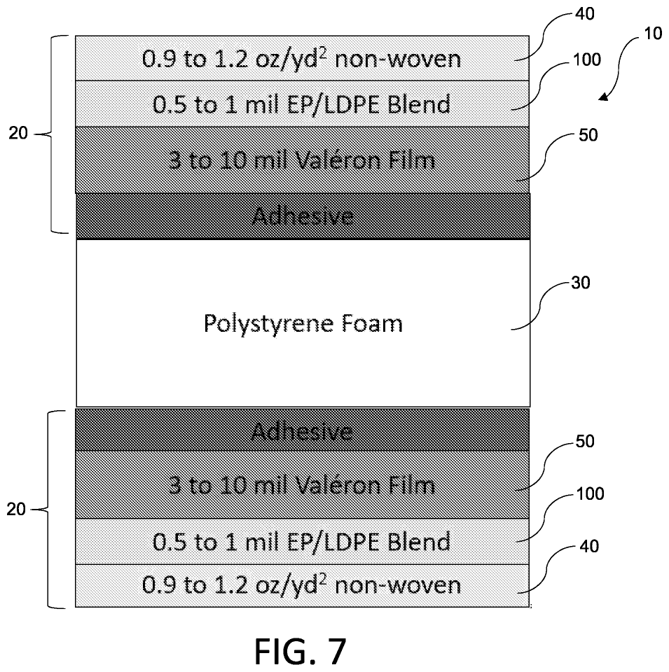

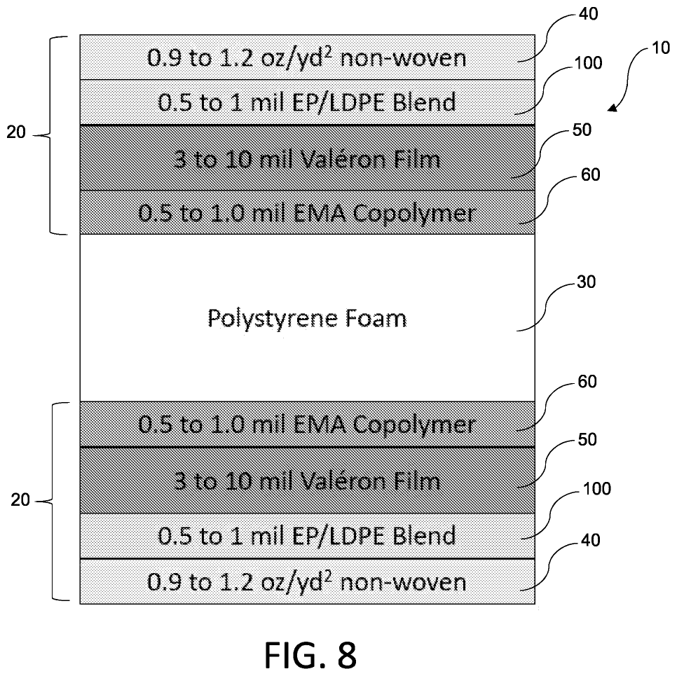

FIGS. 1-8 show various preferred embodiments and/or components of a moisture resistant composite backing board 10. Specifically, FIGS. 1-6 show preferred embodiments of a composite face structure 20 and FIGS. 7 and 8 show preferred embodiments of a backing board 10. Preferably, two composite face structures 20 are positioned on each side of a central polystyrene foam core 30 to result in a preferred backing board 10.

The foam core 30 preferably provides a central structure to the backing board 10 while reducing weight. Given the desired application, generally along damp environment vertical walls and floors, the sheer strength is less important than the weight and adherence characteristics of the polystyrene core 30. The foam core 30 preferably comprises an expanded polystyrene (“EPS”) or extruded polystyrene (“XPS”).

A composite face structure 20, also called a “facer,” is preferably laminated to each face of the foam core 30. The composite face structure 20 is preferably duplicated on each side of the foam core 30 such that a pair of composite face structures 20 and the foam core 30 together comprise the backing board 10. The composite face structure 20 is preferably applied to both sides of the foam core 30 to allow installation independent of side as well as provide similar mechanical properties on both sides.

The composite face structure 20 may be adhesive laminated to each side of the foam core 30, such as shown in FIGS. 1, 3, 5 and 7. Alternatively, the composite face structure 20 may be thermally laminated to each side of the foam core 30, such as shown in FIGS. 2, 4, 6, and 8.

The composite face structure 20 may be separately manufactured and then subsequently adhered to the foam core 30 in a later operation or may be fabricated in process with the foam core 30. In either event, it is preferable that two composite face structures 20 are produced such that each are positionable on each respective side of the foam core 30.

An outer layer of each composite face structure 20 preferably includes an outer non-woven fabric layer 40. As used herein, the “outer” layer refers to a layer of the backing board 10 that is the outermost layer and is used for tile or similar surface covering adhesion and, on an opposite side of the backing board 10, is used to face and adhere to studs, a wall and/or other framing substrate. The non-woven fabric layer 40 is preferably suitable for bonding of either a tile or similar hard wall surface. One preferred embodiment of the non-woven fabric layer is a polypropylene or PET point bond nonwoven material. A preferred weight range is approximately 0.9 to 1.2 oz/yd² although other weight ranges may be appropriate depending on the balance of the backing board 10 structure.

The composite face structure 20 additionally includes a central film layer 50. As used herein, the term “central” film layer 50 does not necessarily require that the central film layer 50 is a numerically or spatially central layer, only that it is not an outer, exposed layer of the composite face structure 20. Specifically, the central film layer 50 preferably comprises a proprietary VALERON film layer. VALERON film preferably comprises a high-density polyethylene that is oriented and cross-laminated. Preferably two plies of film are crossed at approximately 90 degrees to each other and laminated with a thin layer, for instance 0.5 mils, of polyethylene. A thicker central film layer 50 may be configured with four oriented plies and three laminating layers. In total, a preferred thickness of the central film layer 50 within the composite face structure 20 is approximately 3-10 mils thick. Such a thickness provides stability to the backing board 10 and enables use of a foam core 30 that would otherwise be susceptible to breakage.

The composite face structure 20 further includes an inner copolymer layer 60. As used herein the term “inner” means a layer of material that is adjacent the foam core 30 and/or between the central film layer 50 and the foam core 30. The inner copolymer layer 60 preferably comprises a copolymer such as ethylene-methacrylate (EMA), or in an alternatively embodiment, an ethylene-vinyl acetate (EVA). A suitable EMA includes approximately 20% methacrylate and a density of 0.941 g/cm³. In addition, a suitable EMA includes a melt index of 6 grams/10 minutes and is an extrusion coating grade.

The inner copolymer layer 60 is preferably approximately 0.5 to 1 mil in thickness. As a result, the central film layer 50 is approximately 3 to 20 times thicker than the inner copolymer layer 60. Each of the above-described layers of the composite face structure 20 is preferably extrusion laminated or coated to an adjacent layer.

The inner copolymer layer 60 may be thermally laminated to each side of the foam core 30 thereby attaching the respective composite face structures 20 to each side of the foam core 30.

According to one embodiment of the invention, such as shown in FIGS. 4 and 6, the backing board 10 may further comprise an LDPE layer 70 positioned between the central film layer 50 and the inner copolymer layer 60 in each composite face structure 20. The LDPE layer 70 preferably comprises low density polyethylene (LDPE) having a melt index of approximately 7 grams/10 minutes and a density of approximately 0.917 g/cm³. The LDPE layer 70 is preferably approximately 0.5 to 1.0 mil thick and is of an extrusion coating grade. The LDPE layer is preferably coextruded with EMA to provide a stable melt curtain during extrusion coating and a cost efficiency over traditional EMA copolymers.

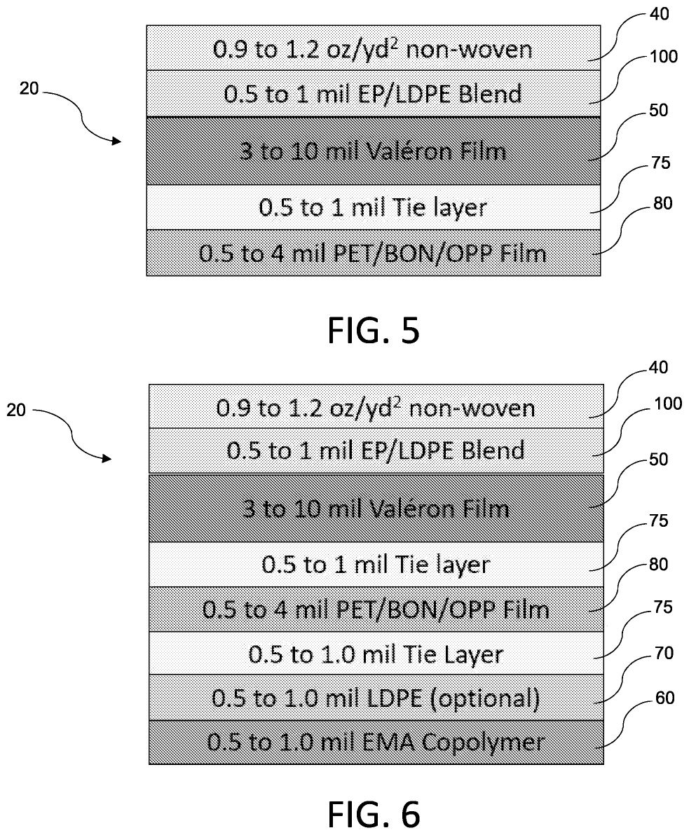

According to one embodiment of the invention, such as shown in FIGS. 5 and 6, the backing board 10 may further include an intermediate film layer 80 of PET, BON and OPP film. The PET, BON and OPP film preferably comprises biaxially oriented films of polyethylene terephthalate, nylon and polypropylene. The intermediate film layer 80 may be positioned as a replacement for the inner copolymer layer 60 when laminated to the foam core 30 with adhesive such as shown in FIG. 5 or may be positioned between the LDPE layer 70 and the central film layer 50 in a thermally laminated structure as shown in FIG. 6. The intermediate film layer 80 is preferably approximately 0.5 to 4 mil in thickness.

In addition, as shown in FIGS. 5 and 6, a tie layer 75 of approximately 0.5 to 1.0 mil may be positioned on one or both sides of the intermediate film layer 80 to bind the intermediate film layer 80 to the central film layer 50 and/or the LDPE layer 70.

According to one preferred embodiment of the invention, the backing board 10 may further include an EP copolymer layer 100 positioned between the central film layer and the outer non-woven fabric layer in each composite face structure. The EP copolymer layer 100 is preferably approximately 0.5 to 1 mil in thickness. The EP copolymer layer 100 is preferred to provide enhanced adhesion to polypropylene point bond nonwovens. EP copolymer can be blended with LDPE to provide better extrusion coating performance with improved adhesion. Additionally, EMA copolymers and EMA/LDPE blends can be used to provide better adhesion to polyester point bond nonwovens.

FIG. 7 shows one exemplary embodiment of the backing board 10 when adhesive laminated to the foam core 30. The backing board 10 includes the polystyrene foam core 30 and the composite face structure 20 adhesively laminated to each face of the foam core 10. The composite face structure 20 in this embodiment includes the outer non-woven fabric layer 40, an EP (ethylene-propylene) blended copolymer layer, a central film layer 50, and an adhesive layer bonding the composite face structure 20 to each side of the foam core 30.

FIG. 8 shows one exemplary embodiment of the backing board 10 having a thermally laminated structure. The backing board 10 includes the polystyrene foam core 30 and the composite face structure 20 thermally laminated to each face of the foam core 30. The composite face structure 20 includes the outer non-woven fabric layer 40, the central film layer 50, the inner film layer 60. A EP copolymer lawyer 100 may additionally be positioned between the central film layer 50 and the non-woven fabric layer 40. It is preferable that each of the central film layer 50 and the inner film layer 60 comprise distinct materials having distinct properties.

While in the foregoing specification this invention has been described in relation to certain preferred embodiments thereof, and many details have been set forth for purpose of illustration, it will be apparent to those skilled in the art that the subject invention is susceptible to additional embodiments and that certain of the details described herein can be varied considerably without departing from the basic principles of the invention.

1. A moisture resistant composite backing board comprising:
a polystyrene foam core;
a composite face structure laminated to each face of the polystyrene foam core, the composite face structure including:
an outer non-woven fabric layer;
a central film layer; and
an inner copolymer layer;
wherein the composite face structure is laminated to each side of the polystyrene foam core along the inner copolymer layer.

2. The moisture resistant composite backing board of claim 1 wherein the inner copolymer layer is EMA.

3. The moisture resistant composite backing board of claim 1 further comprising an LDPE layer positioned between the central film layer and the copolymer layer in each composite face structure.

4. The moisture resistant composite backing board of claim 3 further comprising an intermediate film layer of PET, BON and OPP film positioned between the LDPE layer and the central film layer.

5. The moisture resistant composite backing board of claim 1 wherein the central film layer is a cross-laminated film.

6. The moisture resistant composite backing board of claim 1 wherein the central film layer is approximately 3 to 20 times thicker than the inner copolymer layer.

7. The moisture resistant composite backing board of claim 1 wherein the outer non-woven fabric layer is approximately 0.9 to 1.2 oz/yd².

8. The moisture resistant composite backing board of claim 1 wherein the composite face structure is adhesive laminated to each side of the polystyrene foam core.

9. The moisture resistant composite backing board of claim 1 wherein the composite face structure is thermally laminated to each side of the polystyrene foam core.

10. The moisture resistant composite backing board of claim 1 wherein the central film layer comprises a high-density polyethylene having at least two plies with cross orientation relative to each other.

11. The moisture resistant composite backing board of claim 1 wherein the central film layer is between approximately 3 and 10 mils thick.

12. The moisture resistant composite backing board of claim 1 wherein each layer of the composite face structure is laminated or extrusion coated to an adjacent layer.

13. The moisture composite backing board of claim 1 further comprising an EP copolymer blend layer positioned between the central film layer and the outer non-woven fabric layer in each composite face structure.

14. A moisture resistant composite backing board comprising:
a polystyrene foam core;
a composite face structure laminated to each face of the foam core, the composite face structure including:
an outer non-woven fabric layer;
a central film layer; and
an inner film layer, wherein the central film layer and the inner film layer comprise distinct materials having distinct properties; and
wherein the composite face structure is laminated to each side of the polystyrene foam core along the inner film layer.

15. The moisture resistant composite backing board of claim 14 further comprising an intermediate film layer of a PET, BON and OPP film.
